(19) United States
(12) Patent Application Publication
(10) Pub. No.: US 2025/0134213 A1
(43) Pub. Date: May 1, 2025

(54) Buckle, Buckle Assembly and Respirator

(71) Applicant: 3M INNOVATIVE PROPERTIES COMPANY, St. Paul, MN (US)

(72) Inventors: Judge W. Morgan, III, Oakboro, NC (US); Jeffrey S. Vogus, Monroe, NC (US); Ashok Vellaiah Retnaswamy, Waxhaw, NC (US); Daniel T. Grosse, Monroe, NC (US)

(21) Appl. No.: 18/913,178

(22) Filed: Oct. 11, 2024

Related U.S. Application Data
(60) Provisional application No. 63/546,095, filed on Oct. 27, 2023.

(51) Int. Cl. A44B 11/00; A62B 18/08

(52) U.S. Cl. CPC A44B 11/006; A62B 18/084

(57) ABSTRACT

The present disclosure provides a buckle for adjustably connecting a strap extending from a head harness of a respirator to a mask of the respirator. The buckle includes a main body defining a first end, a second end opposing the first end, and a longitudinal axis extending along a length of the main body from the first end to the second end. The main body includes a first body portion extending from the first end. The first body portion includes a first major surface and a second major surface opposing the first major surface. The main body further includes a second body portion and a plurality of serrations extending from the first major surface and spaced apart from each other with respect to the longitudinal axis. The buckle further includes a ring including a first ring portion and a second ring portion opposing the first ring portion.

### CROSS REFERENCE TO RELATED APPLICATIONS

This application claims priority from U.S. Provisional Application Ser. No. 63/546,095, filed Oct. 23, 2023, the disclosure of which is incorporated by reference in its/their entirety herein.

### TECHNICAL FIELD

The present disclosure relates generally to a buckle, a buckle assembly, and a respirator including the buckle.

### BACKGROUND

Respirators are used in contaminated environments where air cannot be inhaled directly because the air may be noxious and/or contain harmful gases or substances. Examples of respirators include self-contained breathing apparatus (SCBA), air purification respirators (APRs), powered air purification respirators (PAPRs), and the like that supply pressurized air or that filter or cleanse ambient air. A respirator typically includes a mask that should fit the face of the wearer properly. The mask may be a half facemask, which may only cover a nose and a mouth of the wearer. The mask may be a full facemask, which may not only cover the nose and the mouth, but also the remainder of the face of the wearer. Full facemasks may be worn in environments where exposure to the surrounding air may harm the eyes or skin of the wearer.

Straps and buckles are typically used to fit the mask on the face of the wearer. More particularly, the buckle allows the wearer to adjust a tension in the strap so as to fit the mask on his/her face properly. It is important to have less friction in the strap through the buckle which may allow the wearer to easily adjust the tension in the strap with less effort and fit the mask on the face as per his/her comfort and application requirements. At the same time, the buckle should be such that the strap is firmly secured in the buckle when the required fit of the mask is achieved.

### SUMMARY

In a first aspect, the present disclosure provides a buckle for adjustably connecting a strap extending from a head harness of a respirator to a mask of the respirator. The buckle includes a main body defining a first end, a second end opposing the first end, and a longitudinal axis extending along a length of the main body from the first end to the second end. The main body includes a first body portion extending from the first end. The first body portion includes a first major surface and a second major surface opposing the first major surface. The main body further includes a plurality of serrations extending from the first major surface and spaced apart from each other with respect to the longitudinal axis. Each serration from the plurality of serrations tapers from the first major surface to a distal edge. Each serration is inclined towards the first end of the main body, such that the distal edge points towards the first end. The main body further includes a second body portion extending from the first body portion to the second end. The buckle further includes a ring including a first ring portion and a second ring portion opposing the first ring portion. The first ring portion is pivotally connected to the second body portion proximal to the second end, such that the ring is pivotable about a transverse axis perpendicular to the longitudinal axis. The ring extends from the second body portion towards the first end of the main body, such that the second ring portion is disposed above the first major surface of the first body portion. The buckle further includes a roller rotatably disposed around the second ring portion of the ring, such that the roller is rotatable relative to the second ring portion. The buckle further includes a retainer connected to the main body and extending from the second end away from the main body. The retainer is configured to be connected to the mask. The roller is configured to at least partially receive the strap thereon, such that the strap movably loops around the roller. One or more serrations from the plurality of serrations are configured to grip the strap, such that the strap is releasably secured between the roller and the distal edge of each of the one or more serrations.

In a second aspect, the present disclosure provides a buckle assembly for adjustably connecting a head harness of a respirator to a mask of the respirator. The buckle assembly includes a strap extending from the head harness. The strap includes a first strap end and a second strap end spaced apart from the first strap end. The strap is connected to the head harness at the first strap end. The buckle assembly further includes a buckle adjustably coupled to the strap proximal to the second strap end. The buckle includes a main body defining a first end, a second end opposing the first end, and a longitudinal axis extending along a length of the main body from the first end to the second end. The main body includes a first body portion extending from the first end. The first body portion includes a first major surface and a second major surface opposing the first major surface. The main body further includes a plurality of serrations extending from the first major surface and spaced apart from each other with respect to the longitudinal axis. Each serration from the plurality of serrations tapers from the first major surface to a distal edge. Each serration is inclined towards the first end of the main body, such that the distal edge points towards the first end. The main body further includes a second body portion extending from the first body portion to the second end. The buckle further includes a ring including a first ring portion and a second ring portion opposing the first ring portion. The first ring portion is pivotally connected to the second body portion proximal to the second end, such that the ring is pivotable about a transverse axis perpendicular to the longitudinal axis. The ring extends from the second body portion towards the first end of the main body, such that the second ring portion is disposed above the first major surface of the first body portion. The buckle further includes a roller rotatably disposed around the second ring portion of the ring, such that the roller is rotatable relative to the second ring portion. The roller is configured to least partially receive the strap thereon, such that the strap movably loops around the roller. The buckle further includes a retainer connected to the main body and extending from the second end away from the main body. The retainer is configured to be connected to the mask. One or more serrations from the plurality of serrations are configured to grip the strap, such that the strap is releasably secured between the roller and the distal edge of each of the one or more serrations.

In a third aspect, the present disclosure provides a respirator. The respirator includes a mask configured to surround a chin, mouth, nose, and eyes of a user's face. The mask includes at least one tab extending inwards. The respirator further includes a head harness configured to be worn on a head of the user. The respirator further includes at least one buckle assembly of the second aspect. The strap of the buckle assembly is connected to the head harness at the first strap end. The retainer of the buckle is connected to the at least one tab of the mask.

In a fourth aspect, the present disclosure provides a strap for adjustably connecting a head harness of a respirator to a mask of the respirator. The strap includes a first strap end. The strap further includes a second strap end spaced apart from the first strap end. The strap further includes a strap body extending from the first strap end to the second strap end along a length of the strap body. The strap body includes an inelastic portion disposed between the first strap end and the second strap end, a first elastic portion extending from the first strap end to the inelastic portion, and a second elastic portion extending from the inelastic portion to the second strap. The inelastic portion is inelastic. Each of the first elastic portion and the second elastic portion is elastic.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a perspective view of a respirator, according to an embodiment of the present disclosure;

FIG. 2A is a side view of a buckle assembly of the respirator of FIG. 1, according to an embodiment of the present disclosure;

FIG. 2B is a perspective top view of the buckle assembly of FIG. 2A, according to an embodiment of the present disclosure;

FIG. 3A is a perspective top view of a buckle of the buckle assembly of FIG. 2A, according to an embodiment of the present disclosure;

FIG. 3B is another perspective top view of the buckle FIG. 3A, according to an embodiment of the present disclosure;

FIG. 3C is a rear view of the buckle of FIG. 3A, according to an embodiment of the present disclosure;

FIG. 3D is a flipped side view of the buckle of FIG. 3A, according to an embodiment of the present disclosure;

FIG. 3E is a flipped perspective view of the buckle of FIG. 3A, according to an embodiment of the present disclosure;

FIG. 4A is a perspective top view of a main body of the buckle of FIG. 3A, according to an embodiment of the present disclosure;

FIG. 4B is a side view of the main body of FIG. 4A, according to an embodiment of the present disclosure;

FIG. 4C is a perspective bottom view of the main body of FIG. 4A, according to an embodiment of the present disclosure;

FIG. 5A is a perspective top view of a buckle, according to another embodiment of the present disclosure;

FIG. 5B is a perspective bottom view of the buckle of FIG. 5A, according to an embodiment of the present disclosure;

FIG. 6A is a perspective top view of a buckle, according to another embodiment of the present disclosure;

FIG. 6B is a perspective bottom view of the buckle of FIG. 6A, according to an embodiment of the present disclosure;

FIG. 7A is a perspective top view of a buckle, according to another embodiment of the present disclosure;

FIG. 7B is a perspective bottom view of the buckle of FIG. 7A, according to an embodiment of the present disclosure;

FIG. 8A is a perspective top view of a buckle, according to another embodiment of the present disclosure;

FIG. 8B is a perspective bottom view of the buckle of FIG. 8A, according to an embodiment of the present disclosure; and

FIG. 9 is a top view of a strap, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “hazardous or potentially hazardous environmental conditions” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous environmental conditions.

As used herein, the term “hazardous or potentially hazardous environments” may refer to environments that include hazardous or potentially hazardous environmental conditions. The hazardous or potentially hazardous environments may include, for example, chemical environments, biological environments, nuclear environments, fires, industrial sites, construction sites, agricultural sites, mining sites, or manufacturing sites.

As used herein, the term “integral” means that the parts in are joined together as a single continuous part and are not separated from each other by other structures.

As used herein, the term “contaminants” refers to gases, vapors, and particles (including dusts, mists, and fumes) and/or other substances which may be present in air and may be harmful to a person.

As used herein, the term “exhalation valve” refers to a valve that is adapted for use on a respiratory mask to allow a fluid to exit an interior gas space of the respiratory mask when the valve is operatively disposed on the respiratory mask.

The present disclosure relates to a buckle, a buckle assembly, and a respirator. The buckle and the buckle assembly are used to fit a mask of the respirator on a face of a wearer. The respirator may include a self-contained breathing apparatus (SCBA), air purification respirator (APR), a powered air purification respirator (PAPR), and the like that supply pressurized air or that filter or cleanse ambient air. The respirator may be used in hazardous environmental conditions.

Straps and buckles are typically used to fit the mask on the face of the wearer. The buckle allows the wearer to adjust a tension in the strap so as to fit the mask on his/her face properly. Conventional buckles offer high friction due to which the wearer may need to apply a lot of effort to tighten the strap and fit the mask on his/her face properly. In some cases, the friction in the strap through the buckle is so high that the wearer is unable to fit the mask properly as per application requirements and comfort. In some other cases, when the conventional buckle is used with a protective fire-fighting hood, the hood may catch the buckle when the hood is donned by the wearer. Further, the protective fire-fighting hood may release the buckle when the hood is pulled over the wearer's head.

Therefore, it may be desirable to reduce the friction in the strap through the buckle, thereby allowing the wearer to adjust the tension in the strap with ease and fit the mask on the face properly.

The present disclosure provides a buckle for adjustably connecting a strap extending from a head harness of a respirator to a mask of the respirator. The buckle includes a main body defining a first end, a second end opposing the first end, and a longitudinal axis extending along a length of the main body from the first end to the second end. The main body includes a first body portion extending from the first end. The first body portion includes a first major surface and a second major surface opposing the first major surface. The main body further includes a plurality of serrations extending from the first major surface and spaced apart from each other with respect to the longitudinal axis. Each serration from the plurality of serrations tapers from the first major surface to a distal edge. Each serration is inclined towards the first end of the main body, such that the distal edge points towards the first end. The main body further includes a second body portion extending from the first body portion to the second end. The buckle further includes a ring including a first ring portion and a second ring portion opposing the first ring portion. The first ring portion is pivotally connected to the second body portion proximal to the second end, such that the ring is pivotable about a transverse axis perpendicular to the longitudinal axis. The ring extends from the second body portion towards the first end of the main body, such that the second ring portion is disposed above the first major surface of the first body portion. The buckle further includes a roller rotatably disposed around the second ring portion of the ring, such that the roller is rotatable relative to the second ring portion. The buckle further includes a retainer connected to the main body and extending from the second end away from the main body. The retainer is configured to be connected to the mask. The roller is configured to at least partially receive the strap thereon, such that the strap movably loops around the roller. One or more serrations from the plurality of serrations are configured to grip the strap, such that the strap is releasably secured between the roller and the distal edge of each of the one or more serrations.

In the buckle of the present disclosure, the roller rotatably disposed around the second ring portion of the ring may reduce friction while the strap is being moved around the ring and/or the roller. As compared to conventional buckles, the buckle of the present disclosure may allow a relatively easier movement of the strap around the ring and/or the roller. In other words, the inclusion of the roller around the ring may allow the user to easily adjust the tension in the strap with less effort and fit the mask on his/her face as per his/her comfort and application requirements. In this way, the user may not need to apply a lot of effort to adjust the tension in the strap in order to fit the mask on his/her face properly. Further, as the one or more serrations from the plurality of serrations are configured to grip the strap, the strap may be firmly secured in the buckle when the required fit of the mask is achieved.

In some embodiments, the second body portion includes a first arm extending upwardly from the first major surface to the second end of the main body. The second body portion further includes a second arm extending from the first body portion to the second end of the main body. The second arm is spaced apart from the first arm at the second end. The second body portion further includes a curved section joining the first arm and the second arm proximal to the first body portion. The first arm, the second arm, and the curved section together define a groove therebetween at the second end of the main body. The groove extends along the transverse axis. The groove is C-shaped and open at the second end of the main body. The groove at least partially and pivotally receives therein the first ring portion of the ring.

In some embodiments, the first arm includes a ramped surface at the second end of the main body. The ramped surface includes a lower edge proximal to the second arm and an upper edge distal to the second arm and opposing the lower edge. The ramped surface is inclined obliquely to the longitudinal axis, such that the upper edge is farther from the first end of the main body as compared to the lower edge. The retainer extends from the first arm and is disposed adjacent to the upper edge of the ramped surface, such that the ramped surface is inclined obliquely to and away from the retainer.

The oblique inclination of the ramped surface to and away from the retainer may minimize snagging associated with the buckle of the present disclosure which was otherwise experienced by users while using protective fire-fighting hoods with the conventional buckles. In other words, when the buckle of the present disclosure is used with a protective fire-fighting hood, the hood may not catch the buckle when the hood is donned by the user. Further, due to inclusion of the ramped surface, the protective fire-fighting hood may not release the buckle of the present disclosure as the hood is pulled over the user's head.

In another embodiment, the present disclosure provides a strap for adjustably connecting a head harness of a respirator to a mask of the respirator. The strap includes a first strap end. The strap further includes a second strap end spaced apart from the first strap end. The strap further includes a strap body extending from the first strap end to the second strap end along a length of the strap body. The strap body includes an inelastic portion disposed between the first strap end and the second strap end, a first elastic portion extending from the first strap end to the inelastic portion, and a second clastic portion extending from the inelastic portion to the second strap. The inelastic portion is inelastic. Each of the first elastic portion and the second elastic portion is elastic. The inelastic portion of the strap may add rigidity to the strap, which may further improve the adjustable connection between the head harness of the respirator and the mask of the respirator.

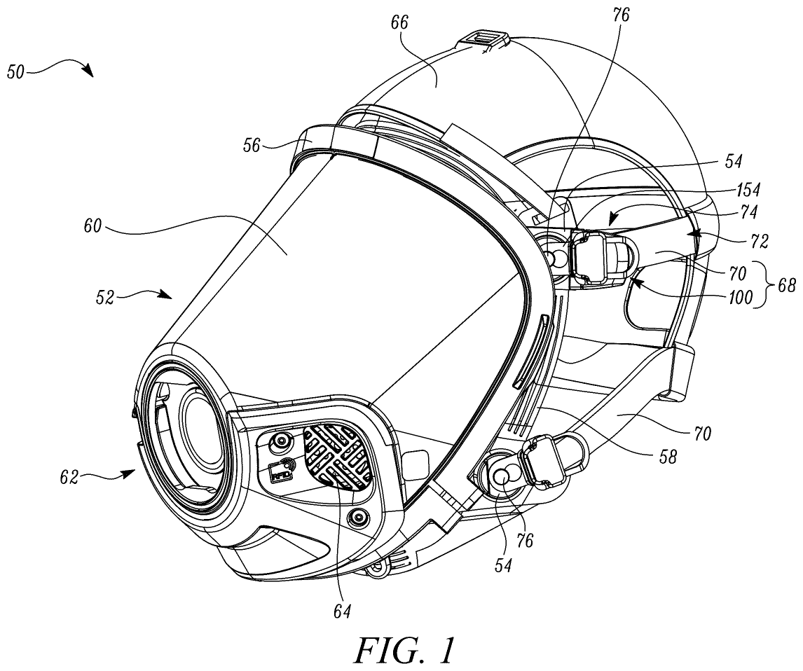

Referring now to Figures, FIG. 1 illustrates a perspective view of a respirator 50, according to an embodiment of the present disclosure. The respirator 50 may be used for any of a number of applications, such as self-contained breathing apparatus (SCBA) applications, air purification respirator (APR) applications, powered air purification respirator (PAPR) applications, and the like. The respirator 50 may be used in hazardous environmental conditions.

The respirator 50 includes a mask 52 configured to surround a chin, mouth, nose, and eyes of a user's face. While the mask 52 described herein is a full facemask (e.g., constructed to cover the eyes as well as the mouth and nose), it should be understood that the mask 52 which embodies the subject matter herein may alternatively be a half facemask (e.g., constructed to cover the mouth and nose but not the eyes) or a quarter mask (e.g., constructed to cover the nose and mouth but not extend under the chin), or the mask 52 may be another type of face covering. The mask 52 is configured to be worn by the user in environments where the user is exposed to hazardous materials, such as, but not limited to, gases, vapors, aerosols (such as dusts, mists, and/or biological agents), and/or the like. The mask 52 described may be constructed for attachment of air purifying cartridges. Alternatively, the mask 52 may be constructed for attachment of hoses for delivering oxygen or other breathable gas, as well as adapters to accept hoses, filters and/or regulators specific to particular duties or to be used in particular environments.

The mask 52 includes at least one tab 54 extending inwards. The mask 52 further includes a mask body 56, a face seal 58, a lens 60, and a docking port 62. The at least one tab 54 may extend from the face seal 58 or the mask body 56. The lens 60 may also be referred to as a visor or face shield. The face seal 58 is configured to directly engage the face of the user and is directly coupled to the lens 60. At least a portion of the face seal 58 may include a compressible material (e.g., rubber, foam, silicone, plastic, and the like) that is pressed against the face of the user to form a substantially sealed interior space (not shown) where the eyes, nose, and mouth of the user are located. The sealed interior space of the mask 52 may include a nose cup (not shown) that surrounds the user's nose and mouth. The nose cup is positioned behind the lens 60.

In some embodiments, the docking port 62 may receive a hose (not shown) for delivering oxygen or filtered breathing air. The other end of the hose may be attached to a powered air purifying blower with filters, to a remote mounted filter, and the like. In other embodiments, the docking port 62 may receive an air purifying cartridge (not shown) centrally located in front of the user's mouth. The cartridge may contain gas absorbents or filters, or combination thereof. The mask 52 is fitted with the type of cartridge that is suitable for removing the particular contaminants in the environment at the time of use.

The mask 52 further includes one or more voice emitters 64 which may amplify the voice of the user to facilitate communication with other users. In some embodiments, an exhalation valve may be used, or a separate passageway for exhalation gases may not be required as the gas inlet could be designed to handle the egress of exhalation gases on a part-time basis.

The respirator 50 further includes a head harness 66 configured to be worn on a head of the user. The mask 52 is adapted to be secured to the user's face by the head harness 66. The respirator 50 further includes at least one buckle assembly 68 for adjustably connecting the head harness 66 of the respirator 50 to the mask 52 of the respirator 50. The at least one buckle assembly 68 may include five buckle assemblies 68 in total. In some embodiments, the at least one buckle assembly 68 may include four buckle assemblies 68 in total or may be more than five buckle assemblies 68 in total. The at least one buckle assembly 68 may be provided around the neck, around the temple, and/or around the head of the user.

The buckle assembly 68 (i.e., each of the at least one buckle assembly 68) includes a strap 70 extending from the head harness 66. The strap 70 includes a first strap end 72 and a second strap end 74 spaced apart from the first strap end 72. The strap 70 of the buckle assembly 68 is connected to the head harness 66 at the first strap end 72. The strap 70 may be stitched to the head harness 66 at the first strap end 72. In some embodiments, the strap 70 may be adhesively coupled to the head harness 66 at the first strap end 72. In some embodiments, the strap 70 may be integral with the head harness 66 and acts as an integral extension of the head harness 66.

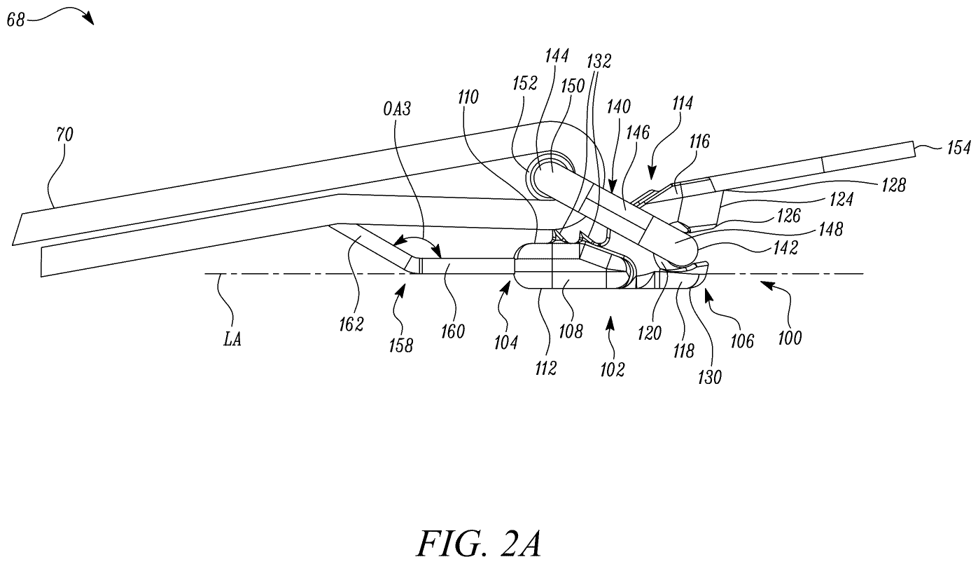

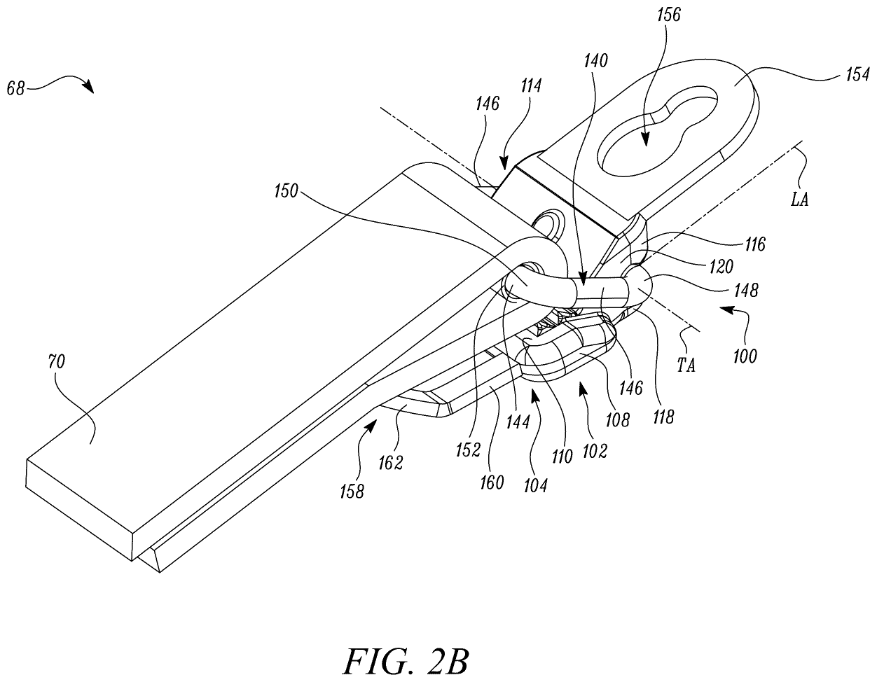

FIG. 2A is a side view of the buckle assembly 68, according to an embodiment of the present disclosure. FIG. 2B is a perspective top view of the buckle assembly 68. Referring to FIGS. 1 to 2B, the buckle assembly 68 further includes a buckle 100 adjustably coupled to the strap 70 proximal to the second strap end 74. The buckle 100 adjustably connects the strap 70 extending from the head harness 66 of the respirator 50 to the mask 52 of the respirator 50.

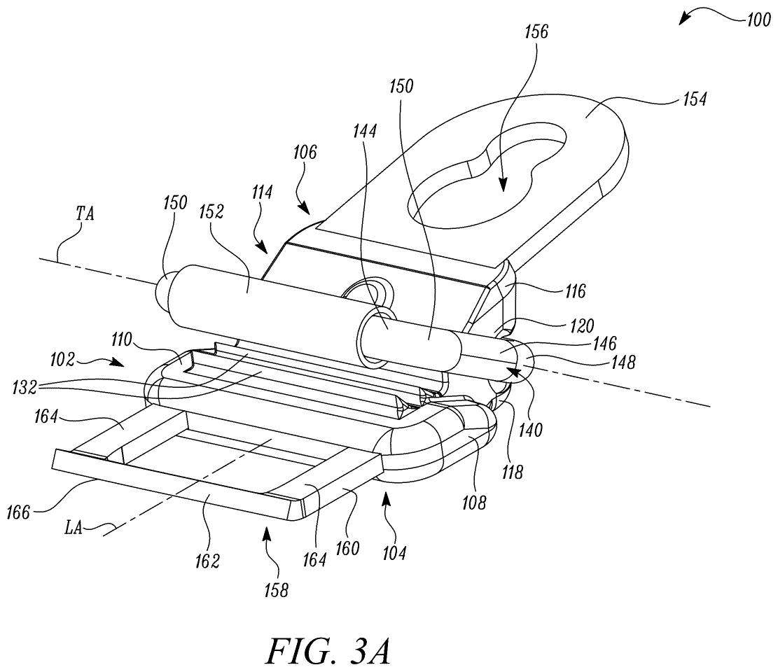

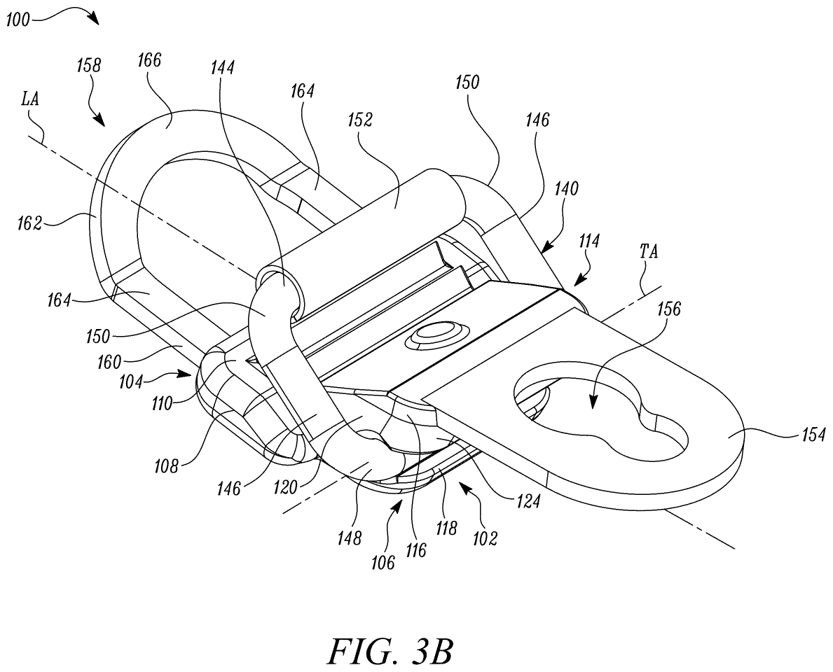

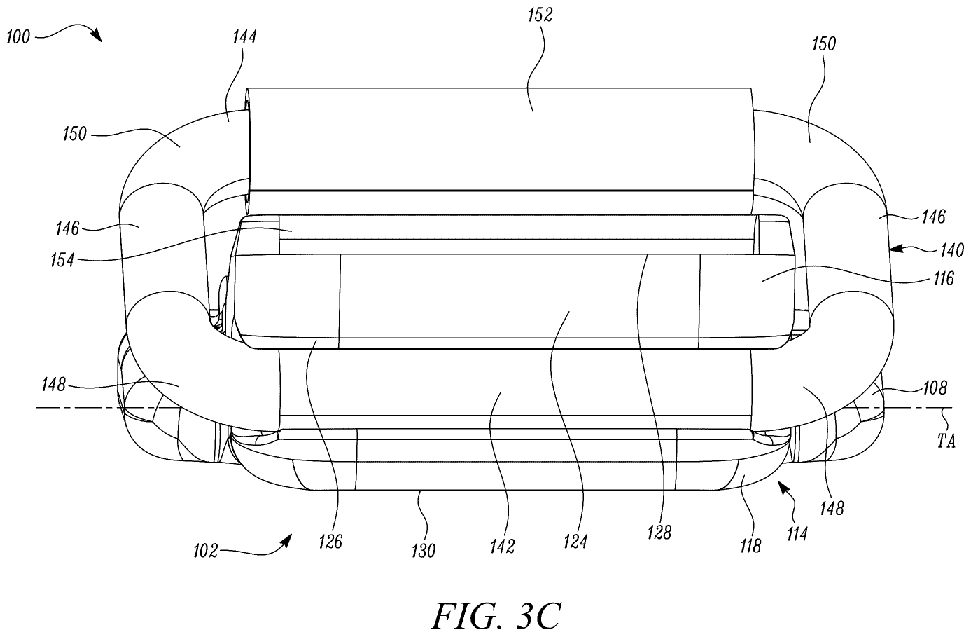

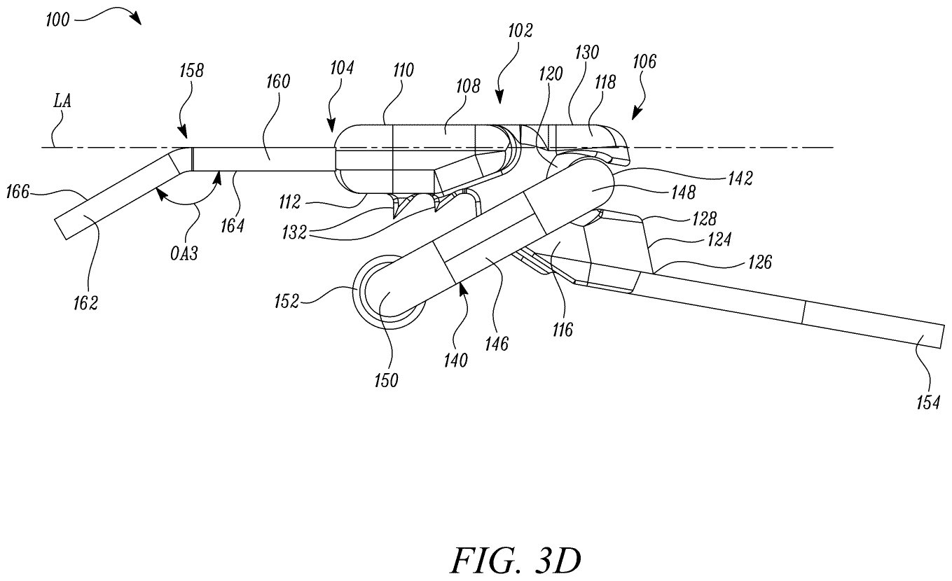

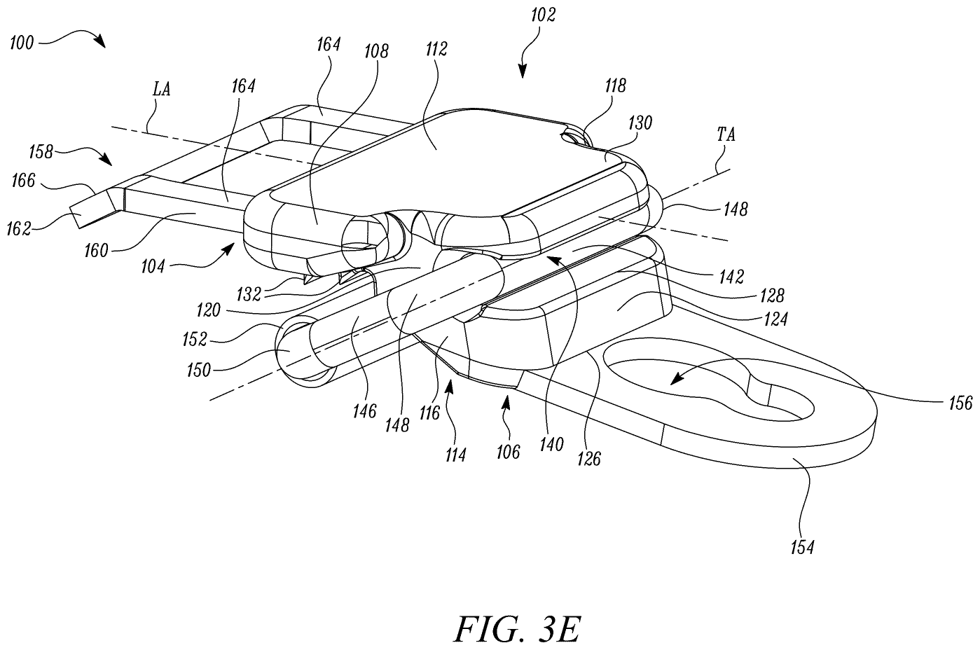

FIG. 3A is a perspective top view of the buckle 100 of the buckle assembly 68 of FIG. 2A, according to an embodiment of the present disclosure. FIG. 3B is another perspective top view of the buckle 100. FIG. 3C is a rear view of the buckle 100. FIG. 3D is a flipped side view of the buckle 100. FIG. 3E is a flipped perspective view of the buckle 100. Referring to FIGS. 3A to 3E, the buckle 100 includes a main body 102 defining a first end 104, a second end 106 opposing the first end 104, and a longitudinal axis LA extending along a length of the main body 102 from the first end 104 to the second end 106.

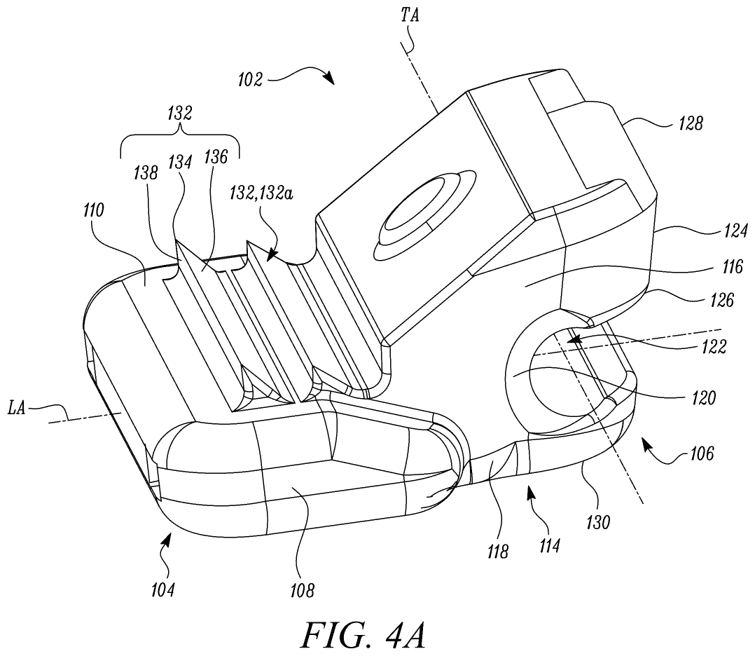

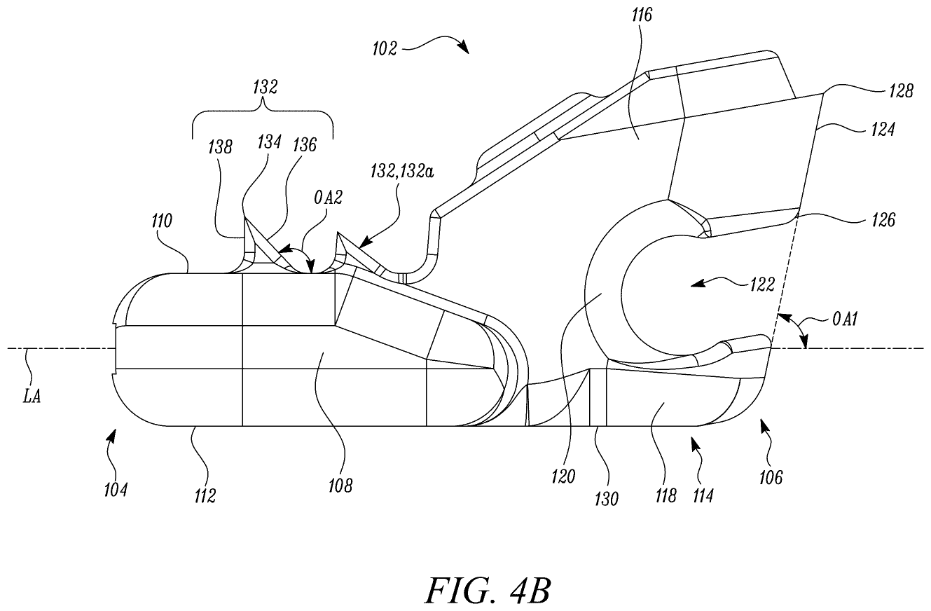

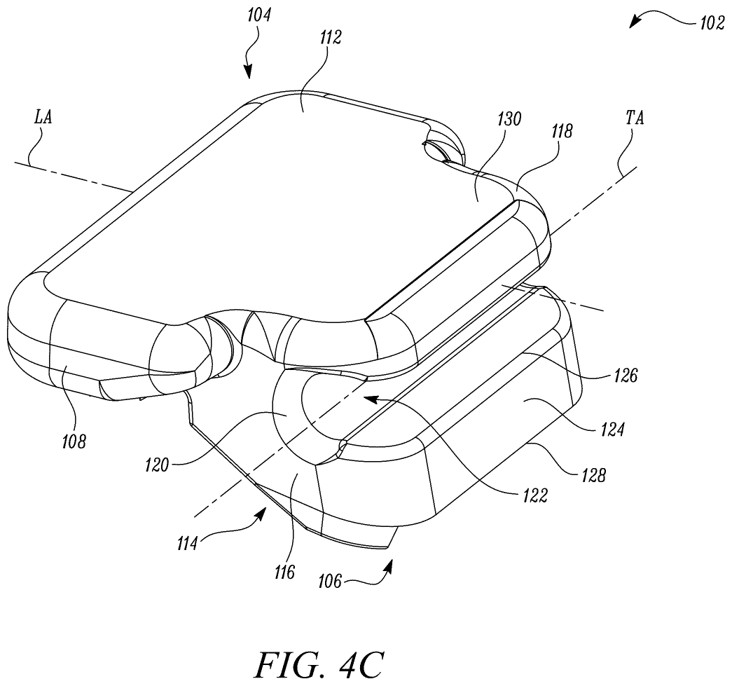

FIG. 4A is a perspective top view of the main body 102 of the buckle 100 of FIG. 3A, according to an embodiment of the present disclosure. FIG. 4B is a side view of the main body 102. FIG. 4C is a perspective bottom view of the main body 102. Referring to FIGS. 3A to 4C, the main body 102 includes a first body portion 108 extending from the first end 104. The first body portion 108 includes a first major surface 110 and a second major surface 112 opposing the first major surface 110. The main body 102 further includes a second body portion 114 extending from the first body portion 108 to the second end 106.

In some embodiments, the second body portion 114 includes a first arm 116 extending upwardly from the first major surface 110 to the second end 106 of the main body 102. The second body portion 114 further includes a second arm 118 extending from the first body portion 108 to the second end 106 of the main body 102. The second arm 118 is spaced apart from the first arm 116 at the second end 106. The second body portion 114 further includes a curved section 120 joining the first arm 116 and the second arm 118 proximal to the first body portion 108. The first arm 116, the second arm 118, and the curved section 120 together define a groove 122 (shown in FIG. 4A) therebetween at the second end 106 of the main body 102. The groove 122 extends along the longitudinal axis LA. Further, the groove 122 is C-shaped and open at the second end 106 of the main body 102.

In some embodiments, the first arm 116 includes a ramped surface 124 at the second end 106 of the main body 102. The ramped surface 124 includes a lower edge 126 proximal to the second arm 118. The ramped surface 124 further includes an upper edge 128 distal to the second arm 118 and opposing the lower edge 126. The ramped surface 124 is inclined obliquely to the longitudinal axis LA, such that the upper edge 128 is farther from the first end 104 of the main body 102 as compared to the lower edge 126. As shown in FIG. 4B, the ramped surface 124 is inclined obliquely to the longitudinal axis LA by a first oblique angle OA1. In some embodiments, the first oblique angle OA1 is between 60 degrees and 80 degrees. In some embodiments, the second arm 118 includes a bottom surface 130 opposite to the first arm 116 and continuous with the second major surface 112 of the first body portion 108.

The main body 102 further includes a plurality of serrations 132 extending from the first major surface 110 and spaced apart from each other with respect to the longitudinal axis LA. Each serration 132 from the plurality of serrations 132 tapers from the first major surface 110 to a distal edge 134 (shown in FIG. 4A). Each serration 132 is inclined towards the first end 104 of the main body 102, such that the distal edge 134 points towards the first end 104. In some embodiments, the plurality of serrations 132 includes a first serration 132a (shown in FIG. 4A) disposed adjacent to the first arm 116. In the illustrated embodiment of FIGS. 3A to 4C, the plurality of serrations 132 includes two serrations 132 in total. In other embodiments, the plurality of serrations 132 may include more than two serrations 132 in total.

In some embodiments, each serration 132 includes an inclined surface 136 (shown in FIG. 4A) extending from the first major surface 110 and inclined towards the first end 104 of the main body 102. The inclined surface 136 is inclined obliquely relative to the first major surface 110. As shown in FIG. 4B, the inclined surface 136 is inclined to the first major surface 110 by a second oblique angle OA2. In some embodiments, the second oblique angle OA2 is between 110 degrees and 170 degrees. Each serration 132 further includes an orthogonal surface 138 (shown in FIG. 4A) extending from the first major surface 110. The orthogonal surface 138 is substantially orthogonal to the first major surface 110. The inclined surface 136 is distal to the first end 104 of the main body 102 and the orthogonal surface 138 is proximal to the first end 104 of the main body 102. The inclined surface 136 and the orthogonal surface 138 intersect each other at the distal edge 134

The buckle 100 further includes a ring 140 including a first ring portion 142 and a second ring portion 144 opposing the first ring portion 142. The first ring portion 142 is pivotally connected to the second body portion 114 proximal to the second end 106, such that the ring 140 is pivotable about a transverse axis TA perpendicular to the longitudinal axis LA. The ring 140 extends from the second body portion 114 towards the first end 104 of the main body 102, such that the second ring portion 144 is disposed above the first major surface 110 of the first body portion 108. The groove 122 at least partially and pivotally receives therein the first ring portion 142 of the ring 140.

In some embodiments, the ring 140 further includes a pair of opposing lateral ring portions 146 extending between respective opposing ends of the first ring portion 142 and respective opposing ends of the second ring portion 144. In some embodiments, each of the first ring portion 142, the second ring portion 144, and the pair of lateral ring portions 146 has a substantially straight cylindrical shape. The ring 140 further includes a pair of first curved interfaces 148 connecting the first ring portion 142 to the respective lateral ring portions 146. The ring 140 further includes a pair of second curved interfaces 150 connecting the second ring portion 144 to the respective lateral ring portions 146, such that the ring 140 has a substantially rounded rectangular shape. In other embodiments, the ring 140 may have a substantially circular shape, or a substantially elliptical shape based on application requirements.

The buckle 100 further includes a roller 152 rotatably disposed around the second ring portion 144 of the ring 140, such that the roller 152 is rotatable relative to the second ring portion 144. Specifically, the roller 152 is rotatable relative to the second ring portion 144 about the transverse axis TA. The roller 152 is configured to at least partially receive the strap 70 thereon, such that the strap 70 movably loops around the roller 152. Further, one or more serrations 132 from the plurality of serrations 132 are configured to grip the strap 70, such that the strap 70 is releasably secured between the roller 152 and the distal edge 134 of each of the one or more serrations 132. In some cases, each of the plurality of serrations 132 may be configured to grip the strap 70.

The buckle 100 further includes a retainer 154 connected to the main body 102 and extending from the second end 106 away from the main body 102. The retainer 154 is configured to be connected to the mask 52. In some embodiments, the retainer 154 includes an aperture 156 extending therethrough. The aperture 156 is keyhole-shaped. The aperture 156 is configured to at least partially and slidably receive a protrusion 76 (shown in FIG. 1) of the mask 52 therethrough in order to connect the buckle 100 to the mask 52. The protrusion 76 may be provided on the at least one tab 54. Therefore, the retainer 154 of the buckle 100 is connected to the at least one tab 54 of the mask 52.

Further, the retainer 154 extends from the first arm 116 and is disposed adjacent to the upper edge 128 of the ramped surface 124, such that the ramped surface 124 is inclined obliquely to and away from the retainer 154. In some embodiments, the main body 102 is an overmold molded over the retainer 154.

The roller 152 rotatably disposed around the second ring portion 144 of the ring 140 may reduce friction while the strap 70 is being moved around the ring 140 and/or the roller 152. As compared to conventional buckles, the buckle 100 may allow a relatively easier movement of the strap 70 around the ring 140 and/or the roller 152. In other words, the inclusion of the roller 152 around the ring 140 may allow the user to easily adjust a tension in the strap 70 with less effort and fit the mask 52 on his/her face as per his/her comfort and application requirements. In this way, the user may not need to apply a lot of effort to adjust the tension in the strap 70 in order to fit the mask 52 on his/her face properly. Further, as the one or more serrations 132 from the plurality of serrations 132 are configured to grip the strap 70, the strap 70 may be firmly secured in the buckle 100 when the required fit of the mask 52 is achieved.

Further, the oblique inclination of the ramped surface 124 to and away from the retainer 154 may minimize snagging associated with the buckle 100 which was otherwise experienced by users while using protective fire-fighting hoods with the conventional buckles. In other words, when the buckle 100 is used with a protective fire-fighting hood, the hood may not catch the buckle 100 when the hood is donned by the user. Further, due to inclusion of the ramped surface 124, the protective fire-fighting hood may not release the buckle 100 as the hood is pulled over the user's head.

In some embodiments, the buckle 100 further includes a holder 158 connected to the main body 102 and extending from the first end 104 away from the main body 102. The holder 158 includes a first holder portion 160 disposed adjacent to the main body 102. The holder 158 further includes a second holder portion 162 extending from the first holder portion 160 opposite to the main body 102. The second holder portion 162 is inclined obliquely to the first holder portion 160 and extends upwardly from the first holder portion 160 away from the second major surface 112. As shown in FIG. 3D, the second holder portion 162 is inclined to the first holder portion 160 by a third oblique angle OA3. In some embodiments, the third oblique angle OA3 is between 110 degrees and 170 degrees. The second holder portion 162 is configured to at least partially and releasably engage with the strap 70. The second holder portion 162 is configured to be disengaged from the strap 70 in order to adjust the strap 70 relative to the buckle 100. In other words, in order to adjust the strap 70 relative to the buckle 100, the user has to first disengage the second holder portion 162 from the strap 70. When there is no contact between the second holder portion 162 and the strap 70, the user may adjust the strap 70 relative to the buckle 100. Specifically, the user is allowed to adjust the tension in the strap 70 when the second holder portion 162 is disengaged from the strap 70. This allows the user to tighten or loosen the strap 70 and the mask 52 of the respirator 50. In some embodiments, the user may couple the mask 52 to his/her coat or turnout gear by hooking the holder 158 with the coat or the turnout gear.

In some embodiments, the first holder portion 160 includes a pair of opposing elongate members 164 spaced apart from each other and extending from the main body 102. The second holder portion 162 includes an arcuate member 166 extending from respective ends of the pair of opposing elongate members 164 opposite to the main body 102. The arcuate member 166 is configured to at least partially and releasably engage with the strap 70.

In some embodiments, the retainer 154 and the holder 158 form a single integral component. The single integral component (combination of the retainer 154 and the holder 158) may be a stamped/formed metallic component. Each of the retainer 154 and the holder 158 may be made up of low carbon steel with a chrome-free duplex coating. In some embodiments, the main body 102 is an overmold molded over the single integral component. The main body 102 may be made up of a polymeric material comprising polyamide, glass fibers, glass beads, nylon, and so on. The ring 140 may be a formed component made up of low carbon steel with the chrome-free duplex coating. The roller 152 may also be a formed component made up of low carbon steel with the chrome-free duplex coating.

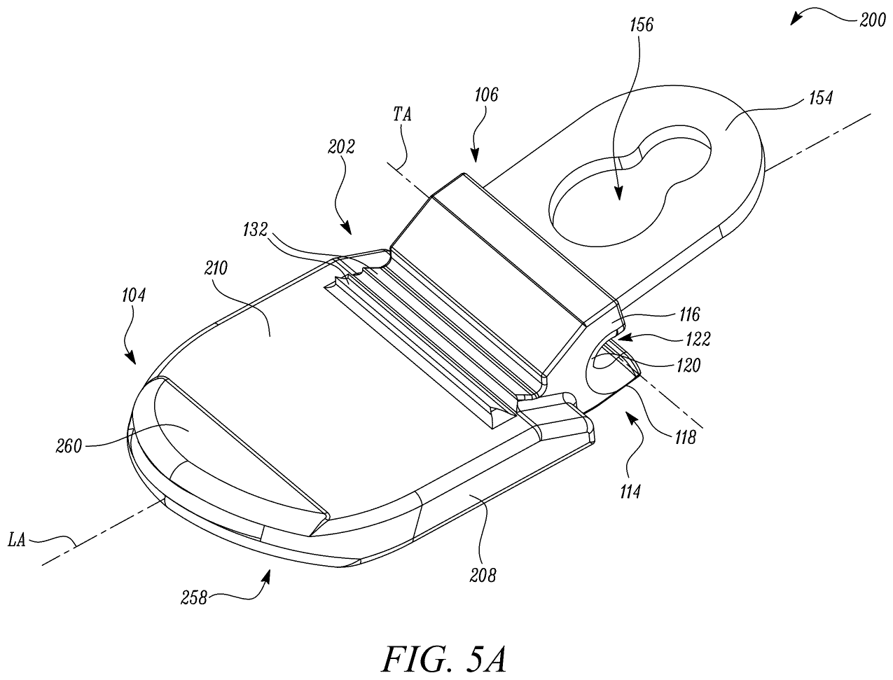

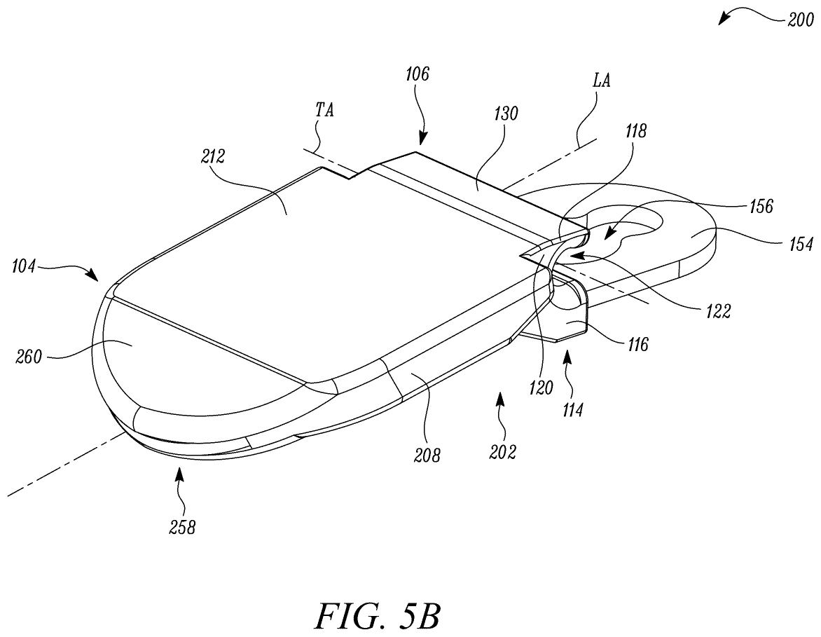

FIG. 5A is a perspective top view of a buckle 200, according to another embodiment of the present disclosure. FIG. 5B is a perspective bottom view of the buckle 200. The buckle 200 is substantially similar to the buckle 100 of FIG. 3A, with common components being referred to by the same numerals. The functional advantage of the buckle 200 is substantially the same as that of the buckle 100 of FIG. 3A. Some components, such as the ring 140 and the roller 152, are not shown in FIGS. 5A and 5B for illustrative purposes.

The buckle 200 includes a main body 202 which is substantially similar to the main body 102 of the buckle 100 shown in FIG. 3A. However, the main body 202 of the buckle 200 includes a first body portion 208 (instead of the first body portion 108). The first body portion 208 includes a first major surface 210 and a second major surface 212 opposing the first major surface 210. In comparison to the first major surface 110 of the buckle 100 of FIG. 3A, the first major surface 210 of the buckle 200 covers more area in a direction away from the second body portion 114. Similarly, in comparison to the second major surface 112 of the buckle 100 of FIG. 3A, the second major surface 212 of the buckle 200 covers more area in the direction away from the second body portion 114. Therefore, the first body portion 208 of the buckle 200 extends for a greater length than that of the first body portion 108 of the buckle 100 of FIG. 3A.

Further, the buckle 200 includes a holder 258 (instead of the holder 158 shown in FIG. 3A) connected to the main body 202 and extending from the first end 104 away from the main body 202. The holder 258 includes an arcuate portion 260 inclined obliquely to the first major surface 210 and extending upwardly from the main body 202 away from the second major surface 212. The arcuate portion 260 is configured to at least partially and releasably engage with the strap 70 (shown in FIGS. 1 and 2A). In some embodiments, the main body 202 and the holder 258 form a single integral component.

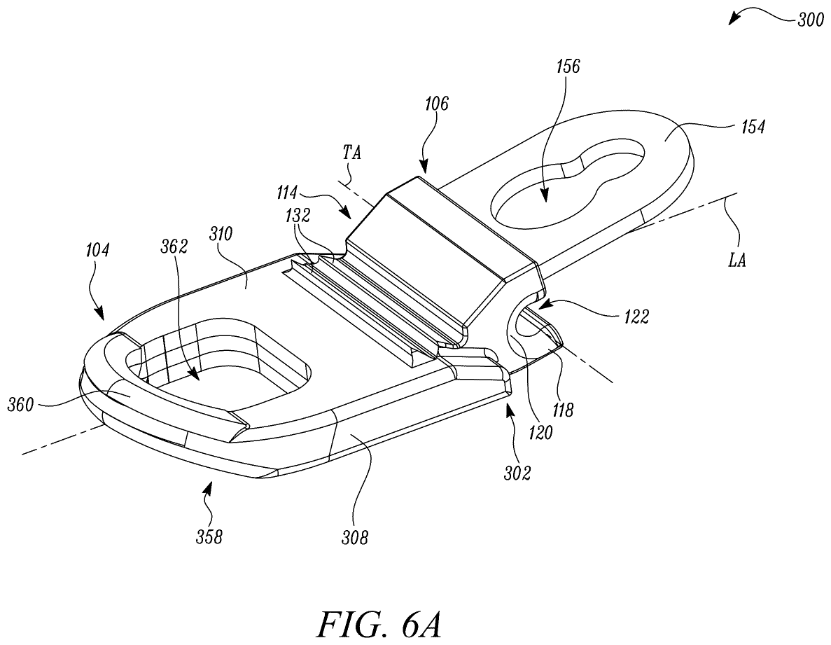

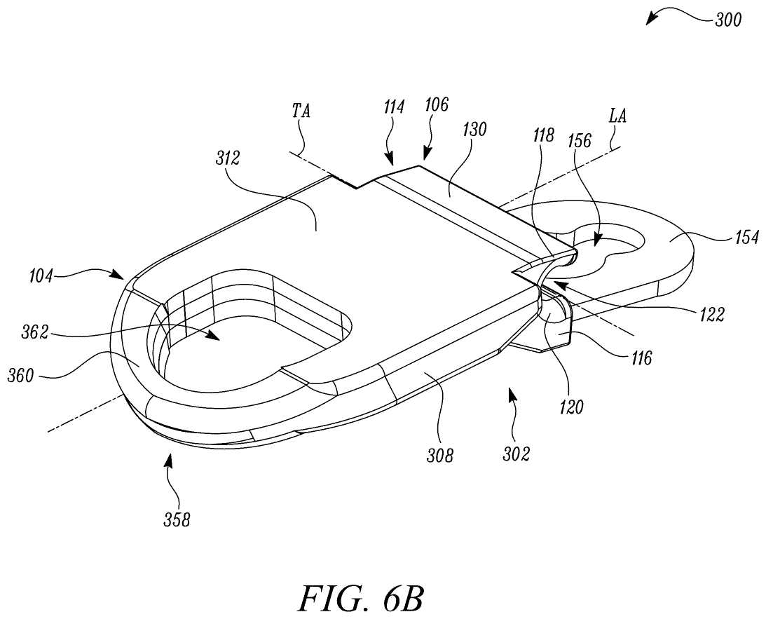

FIG. 6A is a perspective top view of a buckle 300, according to another embodiment of the present disclosure. FIG. 6B is a perspective bottom view of the buckle 300. The buckle 300 is substantially similar to the buckle 200 of FIG. 5A, with common components being referred to by the same numerals. The functional advantage of the buckle 300 is substantially the same as that of the buckle 200 of FIG. 5A. Some components, such as the ring 140 and the roller 152, are not shown in FIGS. 6A and 6B for illustrative purposes.

The buckle 300 includes a main body 302 which is substantially similar to the main body 202 of the buckle 200 shown in FIG. 5A. However, the main body 302 includes a first body portion 308 (instead of the first body portion 208). The first body portion 308 includes a first major surface 310 and a second major surface 312 opposing the first major surface 310. Further, the buckle 300 includes a holder 358 (instead of the holder 258 shown in FIG. 5A) connected to the main body 302 and extending from the first end 104 away from the main body 302. The holder 358 includes an arcuate portion 360 inclined obliquely to the first major surface 310 and extending upwardly from the main body 302 away from the second major surface 312. In the buckle 300, the holder 358 and the first body portion 308 together define a through opening 362. The through opening 362 is at least partially defined between the first major surface 310 and the second major surface 312 of the first body portion 308. In some embodiments, the main body 302 and the holder 358 form a single integral component.

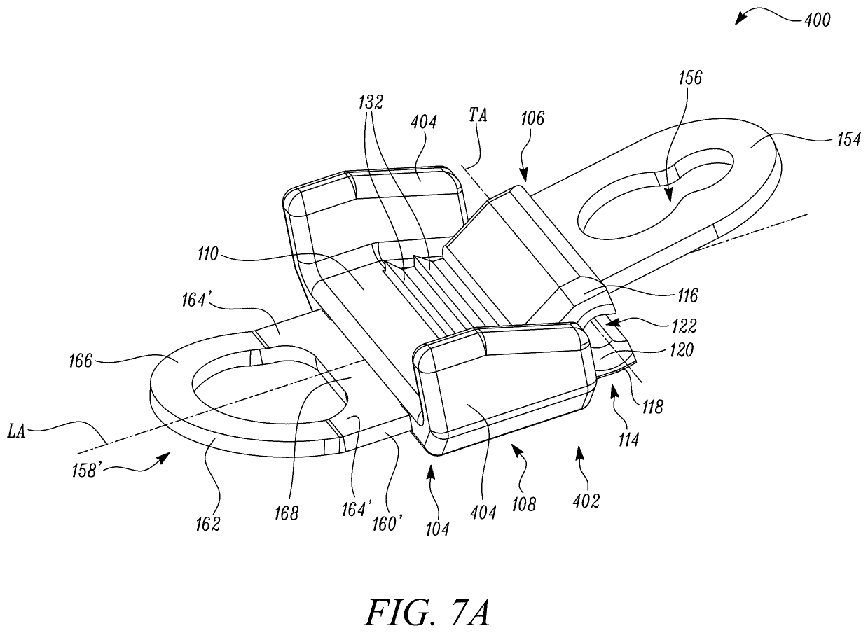

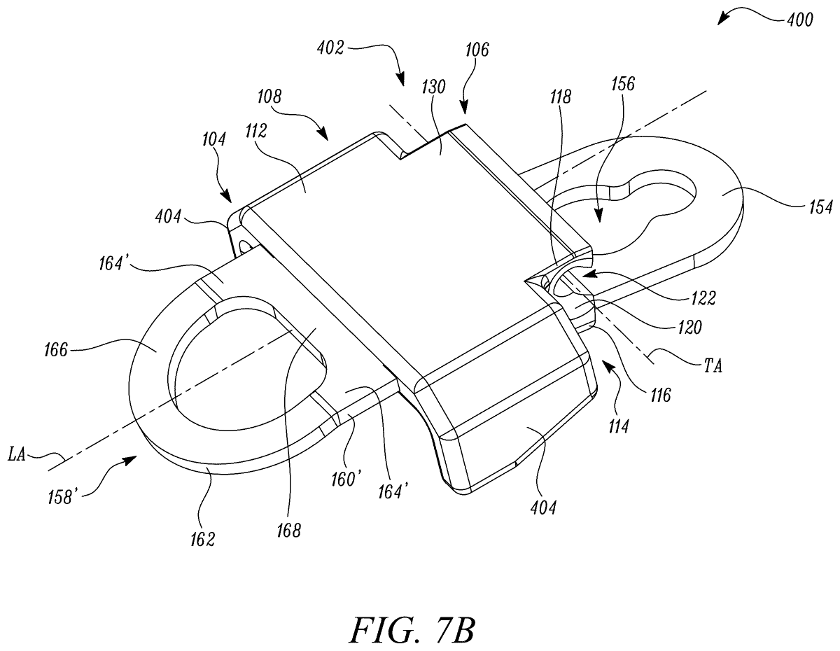

FIG. 7A is a perspective top view of a buckle 400, according to another embodiment of the present disclosure. FIG. 7B is a perspective bottom view of the buckle 400. The buckle 400 is substantially similar to the buckle 100 of FIG. 3A, with common components being referred to by the same numerals. The functional advantage of the buckle 400 is substantially the same as that of the buckle 100 of FIG. 3A. Some components, such as the ring 140 and the roller 152, are not shown in FIGS. 7A and 7B for illustrative purposes.

The buckle 400 includes a main body 402 which is substantially similar to the main body 102 of the buckle 100 shown in FIG. 3A. However, the main body 402 includes a pair of opposing side portions 404 extending upwardly from respective opposing edges of the first body portion 108 away from the bottom surface 130, such that the ring 140 is at least partially disposed between the pair of side portions 404.

Further, the buckle 400 includes a holder 158′ (instead of the holder 158 shown in FIG. 3A) connected to the main body 402 and extending from the first end 104 away from the main body 402. The holder 158′ is substantially similar to the holder 158 shown in FIG. 3A, with common components being referred to by the same numerals. The holder 158′ includes a first holder portion 160′ (instead of the first holder portion 160 shown in FIG. 3A) disposed adjacent to the main body 402. The first holder portion 160′ includes a pair of opposing elongate members 164′ spaced apart from each other and extending from the main body 402. The elongate members 164′ have a different construction than that of the elongate members 164 shown in FIG. 3A. Specifically, the elongate members 164 of the buckle 100 extend for a greater length than that of the elongate members 164′ of the buckle 400. The holder 158′ further includes an intermediate portion 168 connecting the opposing elongate members 164′.

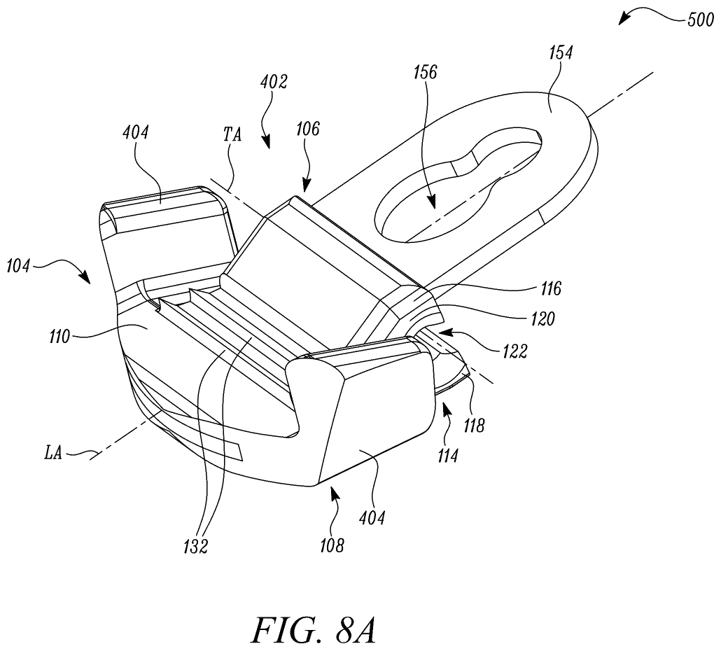

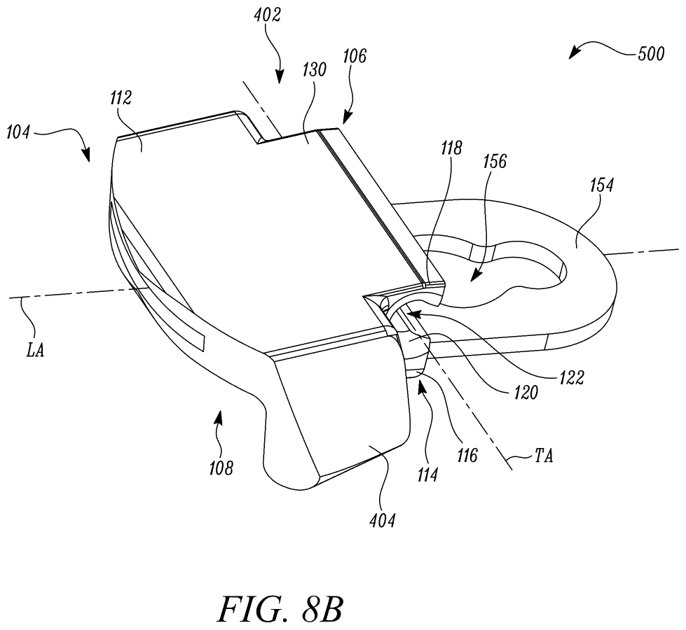

FIG. 8A is a perspective top view of a buckle 500, according to another embodiment of the present disclosure. FIG. 8B is a perspective bottom view of the buckle 500. The buckle 500 is substantially similar to the buckle 400 of FIG. 7A, with common components being referred to by the same numerals. The functional advantage of the buckle 500 is substantially the same as that of the buckle 400 of FIG. 7A. Some components, such as the ring 140 and the roller 152, are not shown in FIGS. 7A and 7B for illustrative purposes. The buckle 500 does not include any holder (i.e., the holder 158′ shown in FIG. 7A).

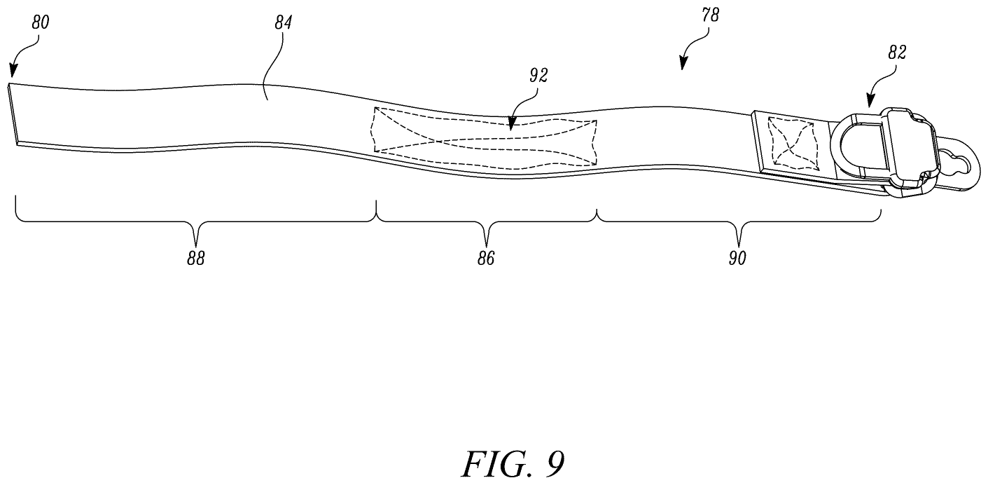

FIG. 9 is a top view of a strap 78 for adjustably connecting the head harness 66 (shown in FIG. 1) of the respirator 50 to the mask 52 of the respirator 50, according to an embodiment of the present disclosure. The strap 78 can be used interchangeably with the strap 70 shown in FIG. 1.

The strap 78 includes a first strap end 80 and a second strap end 82 spaced apart from the first strap end 80. The strap 78 further includes a strap body 84 extending from the first strap end 80 to the second strap end 82 along a length of the strap body 84. The strap body 84 includes an inelastic portion 86 disposed between the first strap end 80 and the second strap end 82. The strap body 84 further includes a first elastic portion 88 extending from the first strap end 80 to the inelastic portion 86. The strap body 84 further includes a second elastic portion 90 extending from the inelastic portion 86 to the second strap end 82. The inelastic portion 86 is inelastic, and each of the first elastic portion 88 and the second elastic portion 90 is elastic.

The inelastic portion 86 of the strap 78 may add rigidity to the strap 78, which may further improve the adjustable connection between the head harness 66 of the respirator 50 (shown in FIG. 1) and the mask 52 of the respirator 50. The first elastic portion 88 and the second elastic portion 90 may allow the user to adjust the tension in the strap 78. In some embodiments, the inelastic portion 86 includes a stitch box 92. The stitch box 92 may include an inelastic material sewn to the inelastic portion 86. In some embodiments, the inelastic portion 86 is centrally located along the length of the strap body 84.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A buckle for adjustably connecting a strap extending from a head harness of a respirator to a mask of the respirator, the buckle comprising:
a main body defining a first end, a second end opposing the first end, and a longitudinal axis extending along a length of the main body from the first end to the second end, the main body comprising:
a first body portion extending from the first end, the first body portion comprising a first major surface and a second major surface opposing the first major surface;
a plurality of serrations extending from the first major surface and spaced apart from each other with respect to the longitudinal axis, wherein each serration from the plurality of serrations tapers from the first major surface to a distal edge, wherein each serration is inclined towards the first end of the main body, such that the distal edge points towards the first end; and
a second body portion extending from the first body portion to the second end;
a ring comprising a first ring portion and a second ring portion opposing the first ring portion, wherein the first ring portion is pivotally connected to the second body portion proximal to the second end, such that the ring is pivotable about a transverse axis perpendicular to the longitudinal axis, and wherein the ring extends from the second body portion towards the first end of the main body, such that the second ring portion is disposed above the first major surface of the first body portion;
a roller rotatably disposed around the second ring portion of the ring, such that the roller is rotatable relative to the second ring portion; and
a retainer connected to the main body and extending from the second end away from the main body, wherein the retainer is configured to be connected to the mask;
wherein the roller is configured to at least partially receive the strap thereon, such that the strap movably loops around the roller; and
wherein one or more serrations from the plurality of serrations are configured to grip the strap, such that the strap is releasably secured between the roller and the distal edge of each of the one or more serrations.

2. The buckle of claim 1, further comprising a holder connected to the main body and extending from the first end away from the main body, wherein the holder comprises:
a first holder portion disposed adjacent to the main body; and
a second holder portion extending from the first holder portion opposite to the main body, wherein the second holder portion is inclined obliquely to the first holder portion and extends upwardly from the first holder portion away from the second major surface;
wherein the second holder portion is configured to at least partially and releasably engage with the strap, and wherein the second holder portion is configured to be disengaged from the strap in order to adjust the strap relative to the buckle.

3. The buckle of claim 2, wherein the first holder portion comprises a pair of opposing elongate members spaced apart from each other and extending from the main body, wherein the second holder portion comprises an arcuate member extending from respective ends of the pair of opposing elongate members opposite to the main body, and wherein the arcuate member is configured to at least partially and releasably engage with the strap.

4. The buckle of claim 2, wherein the retainer and the holder form a single integral component, and wherein the main body is an overmold molded over the single integral component.

5. The buckle of claim 1, further comprising a holder connected to the main body and extending from the first end away from the main body, wherein the holder comprises an arcuate portion inclined obliquely to the first major surface and extending upwardly from the main body away from the second major surface, and wherein the arcuate portion is configured to at least partially and releasably engage with the strap.

6. The buckle of claim 1, wherein each serration comprises:
an inclined surface extending from the first major surface and inclined towards the first end of the main body, wherein the inclined surface is inclined obliquely relative to the first major surface; and
an orthogonal surface extending from the first major surface, wherein the orthogonal surface is substantially orthogonal to the first major surface;
wherein the inclined surface is distal to the first end of the main body and the orthogonal surface is proximal to the first end of the main body, and wherein the inclined surface and the orthogonal surface intersect each other at the distal edge.

7. The buckle of claim 1, wherein the second body portion comprises:
a first arm extending upwardly from the first major surface to the second end of the main body;
a second arm extending from the first body portion to the second end of the main body, wherein the second arm is spaced apart from the first arm at the second end; and
a curved section joining the first arm and the second arm proximal to the first body portion;
wherein the first arm, the second arm, and the curved section together define a groove therebetween at the second end of the main body, the groove extending along the transverse axis, wherein the groove is C-shaped and open at the second end of the main body, and wherein the groove at least partially and pivotally receives therein the first ring portion of the ring.

8. The buckle of claim 7, wherein the first arm comprises a ramped surface at the second end of the main body, the ramped surface comprises a lower edge proximal to the second arm and an upper edge distal to the second arm and opposing the lower edge, wherein the ramped surface is inclined obliquely to the longitudinal axis, such that the upper edge is farther from the first end of the main body as compared to the lower edge, and wherein the retainer extends from the first arm and is disposed adjacent to the upper edge of the ramped surface, such that the ramped surface is inclined obliquely to and away from the retainer.

9. The buckle of claim 7, wherein the second arm comprises a bottom surface opposite to the first arm and continuous with the second major surface of the first body portion.

10. The buckle of claim 7, wherein the plurality of serrations comprises a first serration disposed adjacent to the first arm.

11. The buckle of claim 9, wherein the main body further comprises a pair of opposing side portions extending upwardly from respective opposing edges of the first body portion away from the bottom surface, such that the ring is at least partially disposed between the pair of side portions.

12. The buckle of claim 1, wherein the ring further comprises a pair of opposing lateral ring portions extending between respective opposing ends of the first ring portion and respective opposing ends of the second ring portion.

13. The buckle of claim 12, wherein each of the first ring portion, the second ring portion, and the pair of lateral ring portions has a substantially straight cylindrical shape, and wherein the ring further comprises a pair of first curved interfaces connecting the first ring portion to the respective lateral ring portions and a pair of second curved interfaces connecting the second ring portion to the respective lateral ring portions, such that the ring has a substantially rounded rectangular shape.

14. The buckle of claim 1, wherein the retainer comprises an aperture extending therethrough, wherein the aperture is keyhole-shaped, and wherein the aperture is configured to at least partially and slidably receive a protrusion of the mask therethrough in order to connect the buckle to the mask.

15. The buckle of claim 1, wherein the main body is an overmold molded over the retainer.

16. A buckle assembly for adjustably connecting a head harness of a respirator to a mask of the respirator, the buckle assembly comprising:
a strap extending from the head harness and comprising a first strap end and a second strap end spaced apart from the first strap end, wherein the strap is connected to the head harness at the first strap end;
a buckle adjustably coupled to the strap proximal to the second strap end, the buckle comprising:
a main body defining a first end, a second end opposing the first end, and a longitudinal axis extending along a length of the main body from the first end to the second end, the main body comprising:
a first body portion extending from the first end, the first body portion comprising a first major surface and a second major surface opposing the first major surface;
a plurality of serrations extending from the first major surface and spaced apart from each other with respect to the longitudinal axis, wherein each serration from the plurality of serrations tapers from the first major surface to a distal edge, wherein each serration is inclined towards the first end of the main body, such that the distal edge points towards the first end; and
a second body portion extending from the first body portion to the second end;
a ring comprising a first ring portion and a second ring portion opposing the first ring portion, wherein the first ring portion is pivotally connected to the second body portion proximal to the second end, such that the ring is pivotable about a transverse axis perpendicular to the longitudinal axis, and wherein the ring extends from the second body portion towards the first end of the main body, such that the second ring portion is disposed above the first major surface of the first body portion;
a roller rotatably disposed around the second ring portion of the ring, such that the roller is rotatable relative to the second ring portion, wherein the roller is configured to least partially receive the strap thereon, such that the strap movably loops around the roller; and
a retainer connected to the main body and extending from the second end away from the main body, wherein the retainer is configured to be connected to the mask;
wherein one or more serrations from the plurality of serrations are configured to grip the strap, such that the strap is releasably secured between the roller and the distal edge of each of the one or more serrations.

17. The buckle assembly of claim 16, further comprising a holder connected to the main body and extending from the first end away from the main body, wherein the holder comprises:
a first holder portion disposed adjacent to the main body; and
a second holder portion extending from the first holder portion opposite to the main body, wherein the second holder portion is inclined obliquely to the first holder portion and extends upwardly from the first holder portion away from the second major surface;
wherein the second holder portion least partially and releasably engages with the strap, and wherein the second holder portion is configured to be disengaged from the strap in order to adjust the strap relative to the buckle.

18. The buckle assembly of claim 17, wherein the first holder portion comprises a pair of opposing elongate members spaced apart from each other and extending from the main body, wherein the second holder portion comprises an arcuate member extending from respective ends of the pair of opposing elongate members opposite to the main body, and wherein the arcuate member at least partially and releasably engages with the strap.

19. A respirator comprising:
a mask configured to surround a chin, mouth, nose, and eyes of a user's face, the mask comprising at least one tab extending inwards;
a head harness configured to be worn on a head of the user; and
at least one buckle assembly of claim 16, wherein the strap of the buckle assembly is connected to the head harness at the first strap end, and wherein the retainer of the buckle is connected to the at least one tab of the mask.

20. A strap for adjustably connecting a head harness of a respirator to a mask of the respirator, the strap comprising:
a first strap end;
a second strap end spaced apart from the first strap end; and
a strap body extending from the first strap end to the second strap end along a length of the strap body, the strap body comprising an inelastic portion disposed between the first strap end and the second strap end, a first elastic portion extending from the first strap end to the inelastic portion, and a second elastic portion extending from the inelastic portion to the second strap end, wherein the inelastic portion is inelastic, and wherein each of the first elastic portion and the second elastic portion is elastic.
